(19) United States
(12) Patent Application Publication
(10) Pub. No.: US 2011/0291971 A1
(43) Pub. Date: Dec. 1, 2011

(54) Highly Integrated Touch Screen Handheld Device

(75) Inventors: Yasuo Masaki, Osaka (JP); Sei Kono, Osaka (JP)

(73) Assignee: FUNAI ELECTRIC CO., LTD., Osaka (JP)

(21) Appl. No.: 13/117,194

(22) Filed: May 27, 2011

Related U.S. Application Data
(60) Provisional application No. 61/349,345, filed on May 28, 2010.

(51) Int. Cl. G06F 3/041

(52) U.S. Cl. 345/173

(57) ABSTRACT

An object of the present invention is to provide a highly functional highly integrated handheld device.

The present invention provides a highly integrated handheld device including a control unit, a storage unit, a main body display unit, a first connection unit capable of communicating directly or via an internal network with a first device compliant with a predetermined standard, a second connection unit capable of connecting to a second device not compliant with the predetermined standard, and a third connection unit capable of at least one of near field communication and infrared communication, wherein the control unit can carry out reproducing and displaying in the first device, the second device, and a screen of the main body display unit, transmit control signals to controlled devices through any of the first connection unit to the third connection unit, and divide the main body display unit into multiple screens to display multiple registered applications on the respective screens.

### TECHNICAL FIELD OF THE INVENTION

The present invention relates to a highly integrated handheld device including a touch screen, which is connected to an internal network for controlling various types of devices.

### BACKGROUND OF THE INVENTION

Conventionally, many electric appliances have been used at home. Various electric appliances have been installed and used at home, such as, for example, televisions, recording/playing devices, audio devices, personal computers (PCs), game machines, lightings, heating equipment (air conditioners, stoves, etc.), refrigerators, hot-water supply equipment, clocks, cooking devices (rice cookers), telephones, watches, etc. Some of these electric appliances are connected mutually or externally via an internal network, thereby allowing the execution of information or processing input by the electric appliances through the network. As standards for building the internal network (hereinafter, which may be referred to as a home network), DLNA (Digital Living Network Alliance) (Registered Trademark) has been proposed.

In this type of home network, remote controllers have been proposed for controlling various types of home information appliances (for example, see Japanese Patent Application Laid-Open No. 2007-184745). The remote controller described in Japanese Patent Application Laid-Open No. 2007-184745 includes a liquid crystal display unit which is capable of reproducing and displaying contents, so that the user can, on hand, reproduce and display contents acquired via a home network.

### SUMMARY OF THE INVENTION

The remote controller described in Japanese Patent Application Laid-Open No. 2007-184745 can remotely operate televisions, DVD players, other AV equipment, etc. Furthermore, the remote controller described in Japanese Patent Application Laid-Open No. 2007-184745 can reproduce and display contents acquired from devices (for example, a HDD recorder) connected to a home network, on the liquid crystal display unit of the remote controller. By the way, when a home network is built in conformity with a predetermined standard, the devices which are not compliant with the predetermined standard are not able to be connected to the home network, and thus not able to communicate with the other devices connected to the home network. In general, there are personal computers, electric appliances, etc. purchased in different seasons at home, and there may be a mix of devices compliant with a predetermined standard, which are capable of connecting to a home network (hereinafter, referred to as first devices) and devices not compliant with the predetermined standard (hereinafter, referred to as second devices). For this reason, the remote controller described in Japanese Patent Application Laid-Open No. 2007-184745 is not able to reproduce or display contents on the home network in a television as the second device.

In addition, the remote controller described in Japanese Patent Application Laid-Open No. 2007-184745 functions as a control point for controlling the first devices on a home network, which is not able to transmit control signals to the second devices via the home network. From the viewpoint of convenience for the user, one remote controller is desirably able to control not only the first devices but also the second devices.

In addition, Japanese Patent Application Laid-Open No. 2007-184745 suggests that the remote controller is configured as a dedicated terminal, and in addition, configured as a PDA (Personal Digital Assistant, such as a game machine or a cellular phone) which is able to connect to an external network (hereinafter, which may be referred to as the Internet). However, Japanese Patent Application Laid-Open No. 2007-184745 fails to disclose the specific configurations, which are not clear.

The present invention has been achieved in view of the problems described above, and an object of the present invention is to provide a multifunctional handheld device which is able to collectively manage many electric appliances at home, and further acquire, display, and manage information, etc. by itself. Furthermore, another object of the present invention is to provide a highly functional integrated handheld device which has a function as a multimedia player for reproducing and displaying contents on an internal network and an external network, a function as a universal controller for controlling various types of devices, and a function of using various types of Web services on an external network.

In order to solve the problems described above, a highly integrated handheld device according to the present invention is a highly integrated handheld device capable of connecting to an internal network built in conformity with a predetermined standard, which includes a control unit, a storage unit, a main body display unit, a first connection unit capable of communicating directly or via the internal network with a first device compliant with the predetermined standard, a second connection unit capable of connecting to a second device not compliant with the predetermined standard, and a third connection unit capable of at least one of near field communication and infrared communication, and in the highly integrated handheld device, the control unit can reproduce and display contents stored in the storage unit or the first device connected to the internal network, in the first device connected to the internal network, the second device connected through the second connection unit, and the main body display unit, the control unit can transmit control signals for operating controlled devices including the first device and the second device, to the controlled devices through any of the first connection unit to the third connection unit, and the control unit can divide the main body display unit into multiple screens to display multiple registered applications on the respective screens.

Furthermore, in the highly integrated handheld device according to the present invention, the first connection unit is preferably capable of connecting to an external network. Furthermore, the control unit preferably acquires contents from a server connected to the external network, and reproduces and displays the acquired contents in at least one of the main body display unit and the second display device.

Furthermore, in the highly integrated handheld device according to the present invention, the control unit preferably provides, to a screen of the main body display unit, a first graphical user interface for selecting a content supply source, a content reproducing and displaying destination, and contents to be reproduced and displayed.

Furthermore, in the highly integrated handheld device according to the present invention, the control unit may provide, to the screen of the main body display unit, a second graphical user interface for operating the controlled devices, and transmit control signals for controlling the controlled devices to the controlled devices, on the basis of an operation input through the provided second graphical user interface.

Furthermore, in the highly integrated handheld device according to the present invention, the control unit preferably transmits the control signals to the controlled devices, and receives execution results for the control signals from the controlled devices, through any of the first connection unit to the third connection unit.

Furthermore, in the highly integrated handheld device according to the present invention, the third connection unit preferably conforms with Bluetooth (Registered Trademark) as standards for near field communication.

Furthermore, in the highly integrated handheld device according to the present invention, the control units preferably transmits, through the first connection unit, the control signals to the first device connected to the internal network.

Furthermore, in the highly integrated handheld device according to the present invention, the first connection unit is preferably capable of connecting to an external network, and the control unit preferably displays the second graphical user interface on an information terminal connected to the external network, and transmits the control signals on the basis of a signal input from the information terminal.

Furthermore, in the highly integrated handheld device according to the present invention, the control unit preferably provides, to the screen of the main body display unit, a third graphical user interface for using various types of services provided from the server.

Furthermore, in the highly integrated handheld device according to the present invention, the main body display unit preferably includes a touch screen capable of receiving operations from a user.

Furthermore, in the highly integrated handheld device according to the present invention, the control unit preferably converts the number of pixels for contents stored in the content storage device or the storage unit to the number of pixels corresponding to the second display device, in accordance with processing for scaling, and reproduces and displays the contents with the number of pixels converted in the second display device.

Furthermore, in the highly integrated handheld device according to the present invention, the internal network preferably conforms with DLNA (Registered Trademark), and the first connection unit preferably conforms with at least one of Ethernet (Registered Trademark) and Wi-Fi (Registered Trademark). In addition, the second connection unit preferably conforms with HDMI (Registered Trademark).

### ADVANTAGEOUS EFFECTS OF THE INVENTION

According to the present invention, the highly integrated handheld device can reproduce and display various types of contents on the internal network and the external network in not only the first device connected to the internal network but also the second device indirectly connected to the internal network, and thus achieve a comfortable multimedia environment. In addition, the highly integrated handheld device can operate not only the first device connected to the internal network but also the second device, and thus improve the convenience for the user. In addition, the highly integrated handheld device provides graphical user interfaces with high operability through the touch screen, thus, physical operation buttons, etc, can be reduced, and the housing of the highly integrated handheld device can have a simple structure. In addition, the graphical user interfaces are configured to intensively contain various types of frequently used services, thus allowing the achievement of a user-friendly highly integrated handheld device with high operability and visibility. In addition, with communication interfaces corresponding to various types of communication, the first device and second device serving as operational objects can be easily extended. Other advantageous effects will be described in the section of Detailed Description of Preferred Embodiments.

### BRIEF DESCRIPTION OF THE DRAWINGS

FIG. 1 is an explanatory diagram illustrating a summary of a network system with the application of a highly integrated handheld device according to an embodiment of the present invention;

FIG. 2 is a schematic configuration diagram of a highly integrated handheld device according to the embodiment;

FIGS. 3A to 3D show examples of the appearance of a highly integrated handheld device;

FIG. 4 shows an example of a Home Screen;

FIGS. 5A to 5C show an example of a first GUI in the case of functioning as Multimedia Player;

FIGS. 6A to 6E show an example of a second GUI in the case of functioning as Universal remote controller;

FIGS. 7A to 7C show an example of a third GUI in the case of functioning as GADGET;

FIGS. 8A to 8C show examples of a moving image search screen; and

FIG. 9 shows examples of the use of a highly integrated handheld device.

### DETAILED DESCRIPTION OF PREFERRED EMBODIMENTS

An embodiment of the present invention will be described below with reference to the attached drawings. It is to be noted that the present invention is not to be considered limited the following examples.

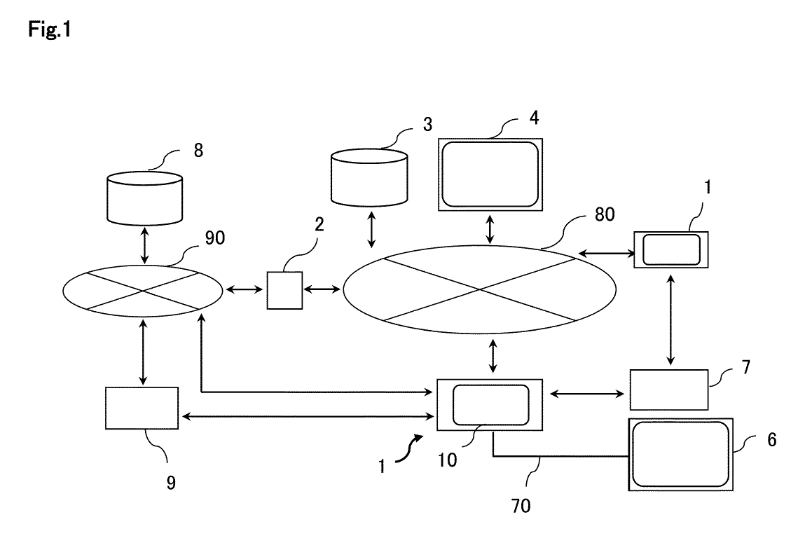

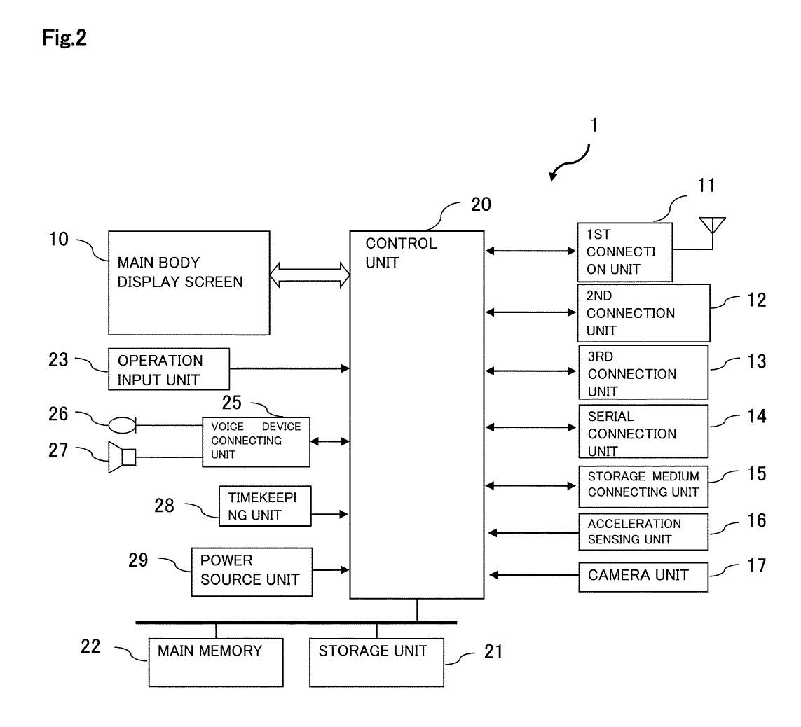

First of all, a summary of a network system with the application of a highly integrated handheld device 1 according to the present embodiment will be described below with reference to FIG. 1, and next, the configuration of the highly integrated handheld device 1 according to the present embodiment will be described with reference to FIG. 2.

FIG. 1 is an explanatory diagram illustrating a summary of a network system with the application of a highly integrated handheld device according to an embodiment of the present invention. The highly integrated handheld device 1 according to the present embodiment is configured to achieve the reduction in size and weight for the purpose of easiness to carry around, which includes a main body display screen 10, and communicates with a plurality of first devices 1, 2, 3, and 4 directly or via an internal network 80 built in conformity with a predetermined standard. Furthermore, the highly integrated handheld device 1 according to the present embodiment communicates with a plurality of second devices 6 via a communication cable 70 or the like. In addition, the highly integrated handheld device 1 also serves as a remote controller for controlling electric appliances directly or via a home network 80. In addition, the highly integrated handheld device 1 is able to connect to an external network (Internet) 90 directly or via a relaying device 2 or the like, and preferably able to communicate with other information terminals 9.

The highly integrated handheld device 1 has the function of Multimedia Player as one of its functions. Specifically, the highly integrated handheld device 1 can reproduce and display the content stored in the first device 3 connected to the internal network 80 or the content stored in the highly integrated handheld device 1, in the display device 4 connected to the internal network 80. In addition, the highly integrated handheld device 1 can reproduce and display the content acquired from the first device 3 connected to the internal network 80 or the content stored in the highly integrated handheld device 1, in the main body display screen 10 of the highly integrated handheld device 1. In addition, the highly integrated handheld device 1 can connect via the communication cable 70 or the like to the second device 6 which is not connected to this internal network to reproduce and display, in the second device 6, the content acquired from the first device 3 connected to the internal network or the content stored in the highly integrated handheld device 1. Furthermore, the highly integrated handheld device 1 reproduces and displays the content acquired via the external network in the main body display screen 10 of the highly integrated handheld device 1, the display device 4, or the second device 6.

It is to be noted that the content herein refers to various types of digital data, for example, video data (such as movies and television programs), still image data (photographs), voice data (such as music and radio programs), text data (such as documents and mails), and combined data thereof (such as Web screens and menu screens). In addition, in the present invention, the term of reproducing and displaying the content includes reproducing voice data without image information.

In addition, the highly integrated handheld device 1 according to the present embodiment has the function of Universal remote controller as one of its functions. Specifically, the highly integrated handheld device 1 is configured to allow control signals to be transmitted to and received from the first devices connected to the internal network 80 and the other second devices unconnected to the internal network. The highly integrated handheld device may provide a graphical user interface (hereinafter, referred to as a GUI) for remote control, via a normal Web browser to computers, cellular phones, etc. connected to the external network. More specifically, the user can also, outside the home, operate various types of home electrical appliances, etc. In addition, the user can carry the highly integrated handheld device 1 outside the home to operate various types of home electrical appliances via the external network (Internet).

In addition, the highly integrated handheld device 1 according to the present embodiment is configured to make various types of Web services available, and provides, as one of its main features, GADGET Application intensively containing various types of information and frequently used functions to the main body display screen 10. Furthermore, the highly integrated handheld device according to the present embodiment may have a function as a telephone using a normal cellular phone network, and a function as a cordless handset junctually connected to a main phone connected to a fixed phone network. Moreover, the highly integrated handheld device according to the present embodiment may be configured to be available as a portable navigation device including a GPS communication function.

The highly integrated handheld device 1 is configured to make cable LAN communication (for example, Ethernet (Registered Trademark)) and/or wireless LAN communication (for example Wi-Fi (Registered Trademark)) available for connecting to the internal network 80. In particular, the Wi-Fi (Registered Trademark) is preferably adopted in order to ensure the portability. In addition, the highly integrated handheld device 1 preferably makes, besides wireless communication (for example, Wi-Fi (Registered Trademark)), at least one of near field communication (for example, Bluetooth (Registered Trademark)), infrared communication, and communication cables available in order to communicate with the first device or the second device without going through the internal network 80.

The first devices refer to devices compliant with a predetermined standard, which can communicate with each other via the internal network 80. The first devices each include the highly integrated handheld device according to the present embodiment, the relaying device 2, a content storage device 3, and the first display device 4. The first device preferably makes, besides cable LAN communication or wireless LAN communication, further at least one of near field communication and infrared communication available.

The second devices refer to devices not compliant with a predetermined standard, which are connected to the internal network 80 via the highly integrated handheld device 1. The second devices each include a second display device 6, and various types of Legacy Home Appliances 7. The second devices preferably make at least one of communication through a communication cable, wireless communication, and infrared communication, for communication with the highly integrated handheld device 1.

The internal network 80 is preferably built in conformity with the DLNA (Registered Trademark) standard as the predetermined standard. In the DLNA (Registered Trademark), the Protocols of Ethernet (Registered Trademark) (IEEE 802.3) and Wi-Fi (Registered Trademark) (IEEE 802.11) are used in the link layer of the TCP/IP protocol system (Internet protocol suite). In addition, the Protocol of the TCP/IP is used in the transport layer and the network layer. However, in the present embodiment, the internal network 80 may be composed of cable LAN communication other than Ethernet (Registered Trademark), wireless LAN communication other than Wi-Fi (Registered Trademark), near field communication (for example, Bluetooth (Registered Trademark) (IEEE 802.15), ZigBee (Registered Trademark) (IEEE 802.15.4)), infrared communication, or a combination thereof.

In the case of the internal network 80 in conformity with the DLNA (Registered Trademark), the first devices are DLNA compliant devices, whereas the second devices are DLNA noncompliant devices. The highly integrated handheld device 1 itself according to the present embodiment is a DLNA compliant device. In addition, the second devices may include DLNA compliant devices besides the DLNA noncompliant devices.

While the internal network 80 has been described above which is preferably configured in conformity with the DLNA (Registered Trademark), the present invention is not limited to this configuration. The highly integrated handheld device 1 according to the present invention can also be applied to internal networks configured on the basis of other standards equivalent to the DLNA (Registered Trademark). In the present embodiment, the highly integrated handheld device 1 will be described below as being applied to the internal network in conformity with the DLNA (Registered Trademark).

The highly integrated handheld device 1 can be connected to the Internet 90 through the relaying device 2. Alternatively, the highly integrated handheld device 1 can also be connected to the Internet 90 directly or via the nearest wireless LAN access point, etc., not shown, without going through the relaying device 2 (DLNA network 80). This connection allows the highly integrated handheld device 1 to acquire the content stored in a server 8 on the Internet 90, and receive various types of Web services.

In addition, the highly integrated handheld device 1 is able to communicate via the Internet 90, etc. with various types of information terminals 9 connected to the Internet 90. This communication also allows the highly integrated handheld device 1 to provide various types of applications of the highly integrated handheld device 1 to the various types of information terminals 9. For example, the highly integrated handheld device 1 can provide the GUI for remote control of the first devices and the second devices (hereinafter, referred to as controlled devices) to screens of the various types of information terminals 9 via a Web browser. This provision allows the user, also outside the home, to control, for example, household controlled devices via the Internet 90, etc. It is to be noted that the communication between the highly integrated handheld device 1 and the various types of information terminals 9 is not limited thereto, and for example, cellular phone networks may be used for the communication.

Further, a plurality of highly integrated handheld devices 1 may be connected to the DLNA network 80. For example, the highly integrated handheld device 1 may be placed in each of multiple rooms. In addition, in a house, one of the highly integrated handheld devices 1 as a base unit may be placed in a living room or the like where the user spends a lot of time, whereas the others of the highly integrated handheld devices 1 as a cordless handsets may be placed in each of the other multiple rooms. The respective highly integrated handheld devices 1 can mutually relay various types of control signals for remote control. What is required for the highly integrated handheld devices 1 as the cordless handsets placed in the multiple rooms is the ability to relay or to transmit and receive at least various types of control signals, and other various types of functions may be thus simplified. Furthermore, remote control repeaters (not shown) for relaying various types of control signals may be placed, instead of placing the highly integrated handheld devices 1 as the cordless handsets in the multiple rooms.

The remote control repeaters are DLNA compliant devices, which receive, via the DLNA network 80, various types of control signals generated for the core highly integrated handheld device 1 to control the second devices. Then, the remote control repeaters transmit the received control signals via near field communication or infrared communication to the second devices (for example, legacy home appliances 7) which are not connected to the DLNA network 80. In particular, the remote control repeaters preferably include an infrared emitting element and an infrared receiving element in order to transmit and receive control signals to and from DLNA noncompliant devices which can receive only conventional infrared remote control signals. For example, the remote control repeaters convert IP remote control signals transmitted from the highly integrated handheld device 1 via the DLNA network, to infrared remote control signals, and transmit the remote control signals to the DLNA noncompliant devices through the use of infrared communication. Thus, in the present embodiment, control signals can also be transmitted to controlled devices which are not connected to the DLNA network 80 out of the range of access by the highly integrated handheld device 1 via infrared communication.

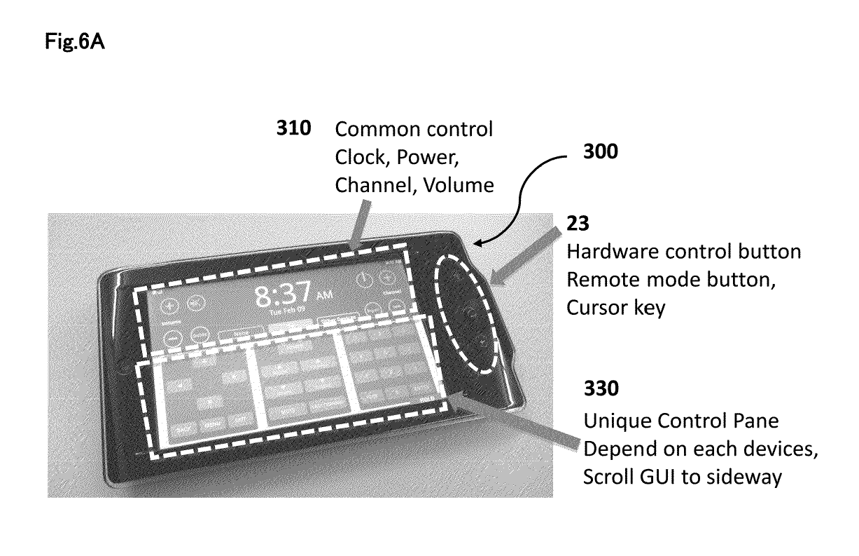

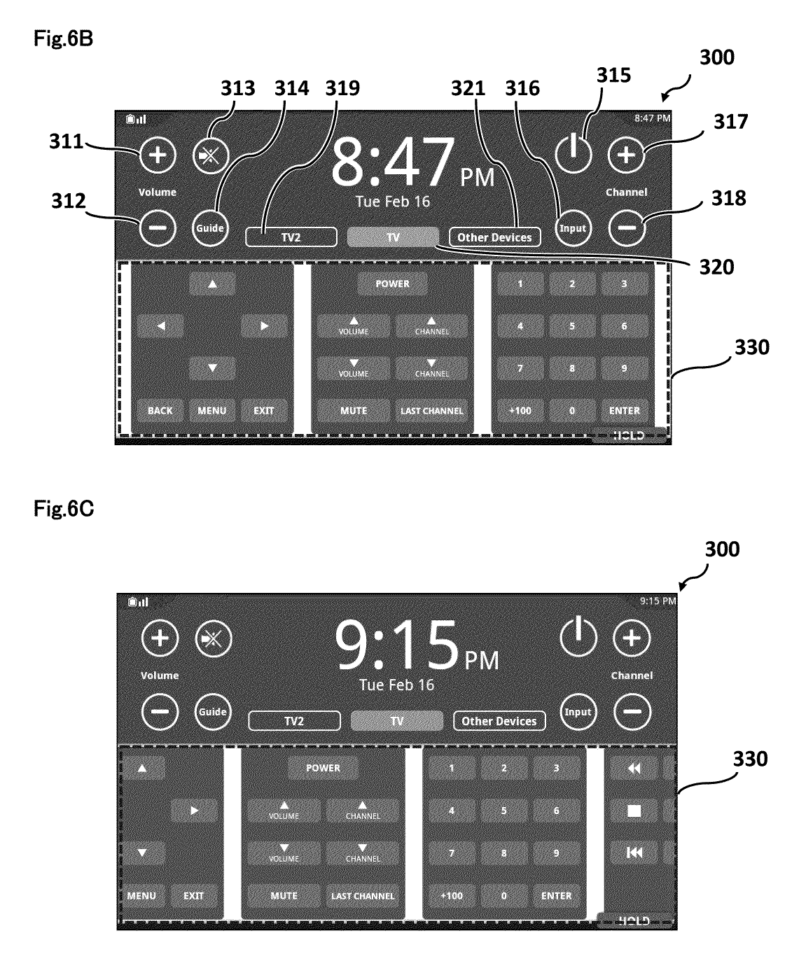

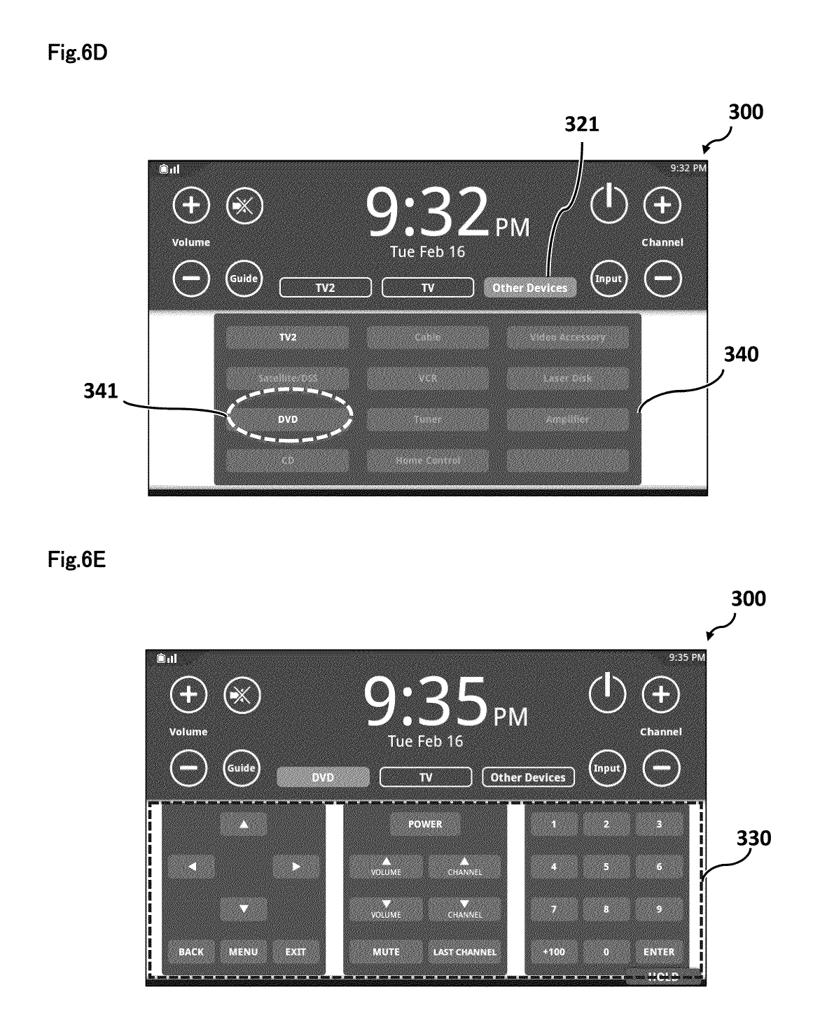

The various types of information terminals 9 are, for example, personal computers, cellular phones, etc. The various types of information terminals 9 are not particularly limited as long as the information terminals 9 are able to connect to the highly integrated handheld device 1 via the Internet 90, etc., and make Web browsers available. The GUI for remote control will be described later with reference to FIGS. 6A to 6E.

The relaying device 2 refers to a device for connecting the respective first devices to each other in the DLNA network 80 and further connecting the DLNA network 80 and the Internet 90. The relaying device 2 has functions such as a modem, routing, and forwarding. The relaying device 2 is, as a DLNA compliant device, preferably a wireless LAN compliant router which functions as an access point for wireless communication in the DLNA network 80.

The content storage device 3 refers to a device for storing contents. The content storage device 3 includes, as DLNA compliant devices, for example, a personal computer, a home server, a DVD recorder, a hard disk recorder, a digital camera, etc.

The first display device 4 refers to a device for reproducing and displaying contents such as moving images and still images. The first display device 4 includes, as DLNA compliant devices, for example, a device with a display function, such as a liquid crystal television, a plasma television, a projection television, a display device, and a projector.

The legacy home appliance 7 is a conventional second device (DLNA noncompliant device), which is preferably able to receive at least control signals transmitted from a remote controller via infrared communication. The legacy home appliance 7 includes, as DLNA noncompliant devices, for example, an audio device, an air conditioner, and a lighting device.

The second display device 6 refers to a device for reproducing and displaying contents such as moving images and still images. The second display device 6 includes, as DLNA noncompliant devices, for example, a device with a display function, such as a liquid crystal television, a plasma television, a projection television, a display device, and a projector. The first display device 4 and the second display device 6 are preferably HDTVs (High Definition TeleVision) which can receive high-definition television broadcast. In this case, it is preferable that in order to ensure high image quality, the highly integrated handheld device 1 and the second display device 6 include a communication interface in conformity with the HDMI (High Definition Multimedia Interface) (Registered Trademark) standards, which are connected to each other via the communication cable 70 in conformity with the HDMI (Registered Trademark) standards.

It is to be noted that while the highly integrated handheld device 1 has been described which is preferably connected to the second display device as a DLNA noncompliant device via the HDMI (Registered Trademark) cable, the present invention is not limited to this connection. What is required is the ability of the highly integrated handheld device 1 to output contents to the second display device 6 without going through the internal network 80. More specifically, the highly integrated handheld device 1 may be connected to the second display device 6 as the second display (DLNA noncompliant device) through other communication means (for example, Wi-Fi (Registered Trademark), Bluetooth (Registered Trademark)).

In other words, what is required is that the highly integrated handheld device 1 connects to the second device through any communication method so that the second device can be connected indirectly to the internal network 80 built in conformity with a predetermined standard (for example, DLNA (Registered Trademark)).

It is to be noted that while the content storage device 3, the first display device 4, etc. have been exemplified as the DLNA compliant devices in FIG. 1, the present invention is not limited to these DLNA compliant devices. As the DLNA compliant devices, other information home appliances (for example, an audio device, an air conditioner, a lighting device, a cooking device, an automatic washing and drying machine, an automatic cleaner, etc.) may be connected to the DLNA network 80.

Now, the DLNA compliant devices are classified into a Digital Media Server (hereinafter, referred to as DMS), a Digital Media Player (hereinafter, referred to as DMP), a Digital Media Controller (hereinafter, referred to as DMC), a Digital Media Renderer (hereinafter, referred to as DMR), etc. as device classes according to the DLNA guide line.

The DMS refers to a device for storing contents (digital media) in the DLNA network. The DMP refers to a device for retrieving the contents stored in the DMS to reproduce and display the retrieved contents. The DMC refers to a device for retrieving the contents stored in the DMS to reproduce and display the retrieved contents in the DMR. The DMR refers to a device for reproducing and displaying the contents transmitted from the DMS on the basis of control by the DMC.

The first display device 4 functions as the DMP or the DMR in the DLNA network 80. The content storage device 3 functions as the DMS to serve as a supply source of contents in DLNA network 80.

The highly integrated handheld device 1 can provide contents stored in its storage unit, and contents stored in external storage media (SD (Registered Trademark), a USB memory, a hard disk, etc.) connected to the highly integrated handheld device 1, to the first display device 4 which functions as the DMP on the DLNA network 80. In this case, the highly integrated handheld device 1 functions as the DMS.

In addition, the highly integrated handheld device 1 can acquire, via the DLNA network 80, contents from the content storage device 3 which functions as the DMS, and reproduce and display the acquired contents on the main body display screen 10. In this case, the highly integrated handheld device 1 functions as the DMP. Furthermore, the highly integrated handheld device 1 can retrieve contents stored in the content storage device 3 which functions as the DMS or the highly integrated handheld device 1 which functions as the DMS, and reproduce and display the retrieved contents in the first display device 4 which functions as the DMR. In this case, the highly integrated handheld device 1 functions as the DMC.

As described above, the highly integrated handheld device 1 according to the present embodiment has the function as the DMS for providing contents to the DMP on the DLNA network 80, the function as the DMP for reproducing and displaying contents acquired from the DMS on the DLNA network 80, on the main body display screen 10 of the highly integrated handheld device 1, and the function as the DMC for reproducing and displaying, on the DMR, contents retrieved by the DMS.

In addition, the highly integrated handheld device 1 can, via the DLNA network 80, acquire contents from the content storage device 3 which functions as the DMS, and reproduce and display the acquired contents on the main body display screen 10 of the highly integrated handheld device 1 and the second display device 6. In this case, the highly integrated handheld device 1 functions as the DMP, because the highly integrated handheld device 1 retrieves the contents stored in the DMS, and reproduces and displays the acquired contents. However, from the standpoint of the user, the highly integrated handheld device 1 retrieves the contents stored in the DMS, and also displays the contents on the second display device 6, which is not the DMR as a DLNA compliant device. Therefore, in this regard, the highly integrated handheld device 1 also functions as a pseudo DMC for a DLNA noncompliant device.

The highly integrated handheld device 1 can reproduce and display not only contents stored in the content storage device 3, but also contents stored in the storage unit of the highly integrated handheld device 1 or contents acquired from the server 8 via the Internet 90, on the main body display screen 10 of the highly integrated handheld device 1, and also reproduce and display the contents in the second display device 6.

FIG. 2 is a schematic configuration diagram of a highly integrated handheld device according to the present embodiment. The highly integrated handheld device 1 according to the present embodiment includes a main body display screen 10, a first connection unit 11, a second connection unit 12, a third connection unit 13, a serial connection unit 14, a storage medium connecting unit 15, an acceleration sensing unit 16, a camera unit 17, a control unit 20, a storage unit 21, a main memory 22, an operation input unit 23, a voice device connecting unit 25, a timekeeping unit 28, and a power supply unit 29. It is to be noted the configuration shown in FIG. 2 is just an example, and depending on the mode of using the highly integrated handheld device 1 and the network system, the respective components may be removed or modified, and other components may be added.

The main body display screen 10 refers to a screen for displaying contents such as video data and still image date. For the main body display screen 10, an Organic Electroluminescence Display, a PDP (Plasma Display Panel), a FED (Field Emission Display), etc. can be used besides a LCD (Liquid Crystal Display). The main body display screen 10 preferably has a size on the order of 7 inches, because the highly integrated handheld device 1 is carried and used at home by the user. In addition, as for the number of pixels, WVGA (Wide VGA: 800×480 pixels), FWVGA (Full Wide VGA: 854×480 pixels), SVGA (Super VGA: 800×600 pixels), etc. are adopted for the main body display screen 10.

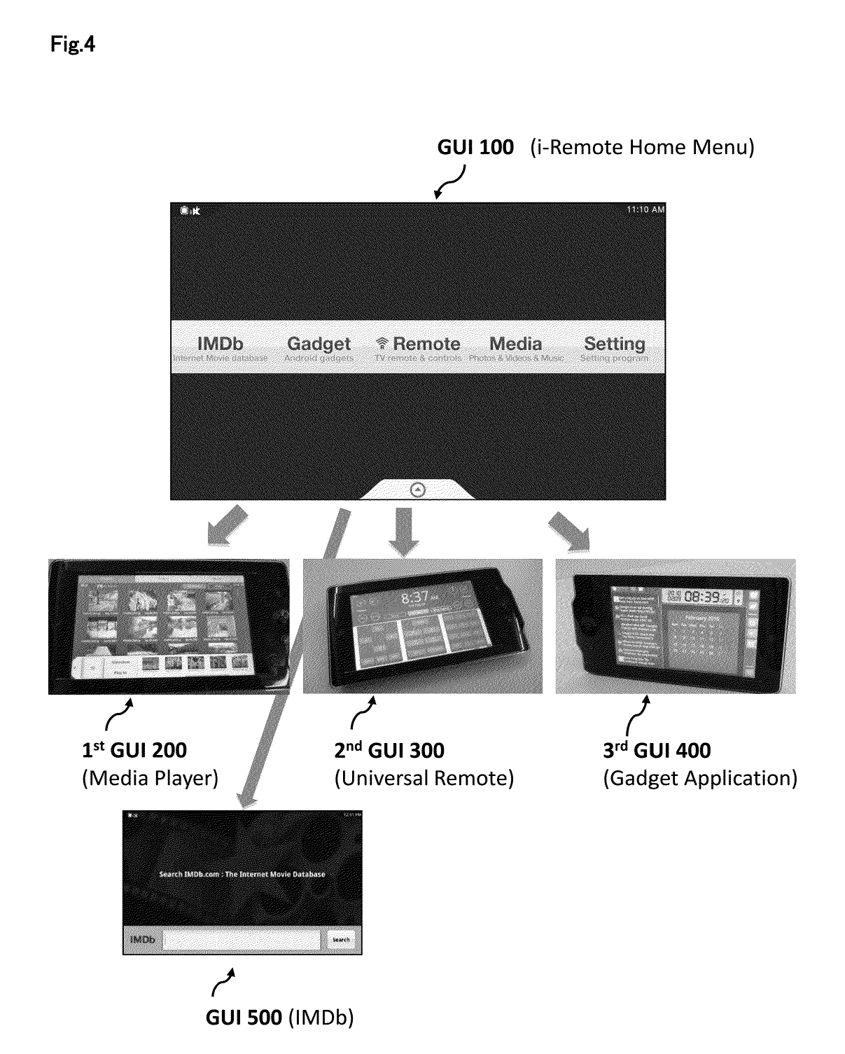

Furthermore, the main body display screen 10 preferably has a touch screen. The touch screen is a transparent screen with an element placed for contact sensing. The user can input various types of operations by touching the screen with a finger or a pen. The main body display screen 10 is provided with various types of operable GUIs by the user. The various types of GUIs include, for example, various types of menu screens, various types of operation buttons, icons for various types of applications, and software keyboards. The user can, by operating these elements, input various types of instructions to the highly integrated handheld device 1 to execute various types of processing. Details on the GUIs will be described later with reference to FIGS. 4 to 8.

The first connection unit 11 is a communication interface for communicating with each DLNA compliant device via the DLNA network 80 (relaying device 2). The first connection unit 11 preferably corresponds to a cable LAN and/or a wireless LAN, and in particular, preferably corresponds to Wi-Fi (Registered Trademark) as a wireless LAN. In addition, the first connection unit 11 may be configured to make it possible to communicate directly with the first device through Wi-Fi (Registered Trademark), Bluetooth (Registered Trademark), etc. Furthermore, the first connection unit 11 may be configured to make it possible to connect to the nearest wireless LAN access point (not shown) and connect to the Internet 90 without going through the DLNA network 80. In addition, the first connection unit 11 may be configured to make it possible to communicate with the various types of information terminals 9 via a cellular phone network or the like.

The second connection unit 12 is an interface for communicating with DLNA noncompliant devices via the communication cable 70. In the case of connecting to the second display device 6 as a DLNA noncompliant device, the second connection unit 12 serves as an interface for inputting and outputting video signals, voice signals, etc. The second connection unit 12 preferably uses a multimedia interface in conformity with, for example, the HDMI (Registered Trademark) standards, in order to output high-definition contents to the second display device 6. In this case, a HDMI (Registered Trademark) cable is used for the communication cable 70. It is to be noted that the second connection unit 12 is not limited to this configuration, and may be an interface which is able to communicate with DLNA noncompliant devices through the use of an appropriate communication means. For example, the second connection unit 12 may be configured to make it possible to communicate directly with the second device through Wi-Fi (Registered Trademark), Bluetooth (Registered Trademark), infrared communication, etc.

Furthermore, the second connection unit 12 may include a scaler for executing the processing for scaling on the hardware. This scaler converts the number of pixels for contents read out from a frame buffer provided in a main memory 22 of the highly integrated handheld device 1 to the number of pixels according to the second display device 6, and outputs the contents with the number of pixels converted to the second display device 6.

The third connection unit 13 is an interface for directly transmitting and receiving control signals for remote control to and from controlled devices without going through the DLNA network 80. The third connection unit 13 is preferably configured to correspond to at least one of near field communication (for example, Bluetooth (Registered Trademark)) and infrared communication. The third connection unit 13, via near field communication or infrared communication, transmits control signals for controlling the controlled devices toward the controlled devices, and receives execution results, etc. from the controlled devices.

The highly integrated handheld device 1 according to the present embodiment may transmit control signals for remote control from the first connection unit 11 or the second connection unit 12. More specifically, depending on the format of a communication interface provided on the controlled device side and the installation site of the controlled devices, the highly integrated handheld device 1 can transmit control signals from any one of the first connection unit 11 to the third connection unit 13.

The serial connection unit 14 is a general-purpose interface for connecting various types of storage devices (for example, hard disks, personal computers, etc). The serial connection unit 14 is preferably configured in conformity with, for example, the USB (Universal Serial Bus) standards. In this case, the serial connection unit 14 may be connected to a USB memory, or may be connected to various types of storage devices through a USB cable.

The storage medium connecting unit 15 is an interface for connecting a storage medium. As the storage medium, for example, memory cards can be used such as an SD (Registered Trademark) card, a picture card, and a compact flash. The highly integrated handheld device 1 can read contents stored in various types of connected storage media through the storage medium connecting unit 15. In addition, the highly integrated handheld device 1 can transmit and receive various types of data including contents between the highly integrated handheld device 1 and various types of storage devices (or storage media) through the serial connection unit 14 (or the storage medium connecting unit 15).

The acceleration sensing unit 16 is a sensor for sensing the attitude, etc. of the highly integrated handheld device 1 along with the change in acceleration of gravity. The highly integrated handheld device 1 can change the display orientation of the main body display screen 10, depending on the change in attitude. The camera unit 17 includes an optical system and an image sensor, which can take moving images and still images. The power supply unit 29 is composed of a dedicated power supply circuit, which supplies electric power to the respective units. The power supply unit 29 may be configured to be powered externally via a power cable, or may be composed of a built-in battery.

The control unit 20 executes various types of processing of the highly integrated handheld device 1. For example, the control unit 20 loads, with a processor, not shown, various types of programs stored in the storage unit 21 described later into the main memory 22 described later, reads out the various types of loaded programs, and makes the hardware in cooperation with the programs to achieve the processing in various types of applications. In the control unit 20, a scaler may be further configured which executes the processing for scaling on the software. This scaler converts the number of pixels for acquired contents to a smaller or larger number of pixels, in accordance with the capacity of a frame buffer deployed on the main memory 22.

The processing for scaling executed by the software increases the burden on the processor at lower speed as compared with the processing for scaling executed by the hardware. However, the processing for scaling executed by the software allows the selection of the processing for scaling according to the object and desired image quality, and thus has the advantage of being able to reduce the degradation of image quality.

In addition, the control unit 20 can execute pairing with a Bluetooth (Registered Trademark) compliant device, and execute connection settings between the control unit 20 and the Bluetooth (Registered Trademark) compliant device to be paired. In addition, the conventional legacy home appliances 7 may respectively use different standards of infrared communication for each maker. For this reason, the control unit 20 preferably has a function of learning each infrared remote control signal so that the formats and parameters of infrared communication can be stored which are different for each maker. This function allows the control unit 20 to transmit control signals corresponding to each controlled device through the third connection unit 13.

The storage unit 21 is composed of a nonvolatile semiconductor memory. The storage unit 21 stores various types of programs executed by the control unit 20, and contents. For the storage unit 21, for example, a flash memory or the like is preferably used. However, the storage unit 21 is not limited to the use of a flash memory, the hard disk or other storage media may be used. Hereinafter, the storage unit 21, various types of storage devices connected to the serial connection unit 14, and various types of storage media connected to the storage medium connecting unit 15 may be collectively referred to simply as a storage unit of the highly integrated handheld device.

The main memory 22 is a volatile semiconductor memory which can be accessed directly by the processor (not shown). The main memory 22 stores various types of programs executed by the processor. In addition, the main memory 22 is preferably provided with at least one frame buffer for temporarily writing the contents to be displayed on the main body display screen 10 or the second display device 6 on the basis of control by the control unit 20.

The operation input unit 23 is a physical interface to which various types of operations are input by the user, which is composed of, for example, various types of push-button switches, four-way movement switches, etc. The user can carry out, through the operation input unit 23, operations such as power-on and power-off, volume control, cursor motions and selections on various types of menu screens, and cancels.

The voice device connecting unit 25 is an interface for connecting a voice input device 26 and a voice output device 27. For the voice input device 26, for example, microphones can be used. For the voice output device 27, for example, speakers, earphones, headphones, etc. can be used. These voice devices input and output voice sounds such as voice chat, video chat, voice memos, and IP phones. In addition, voice sounds are output such as music reproduction, video reproduction, various types of warning sounds, and Internet radio. The timekeeping unit 28 clocks the date and time with the use of an internal clock. In addition, the timekeeping unit 28 may acquire the time from the Internet time server, etc.

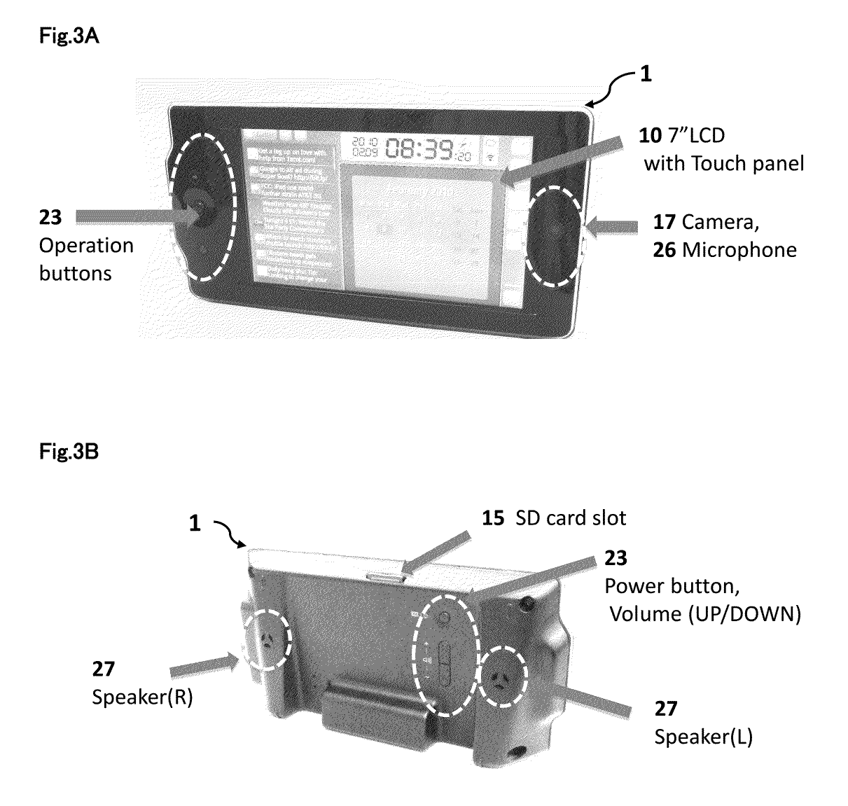

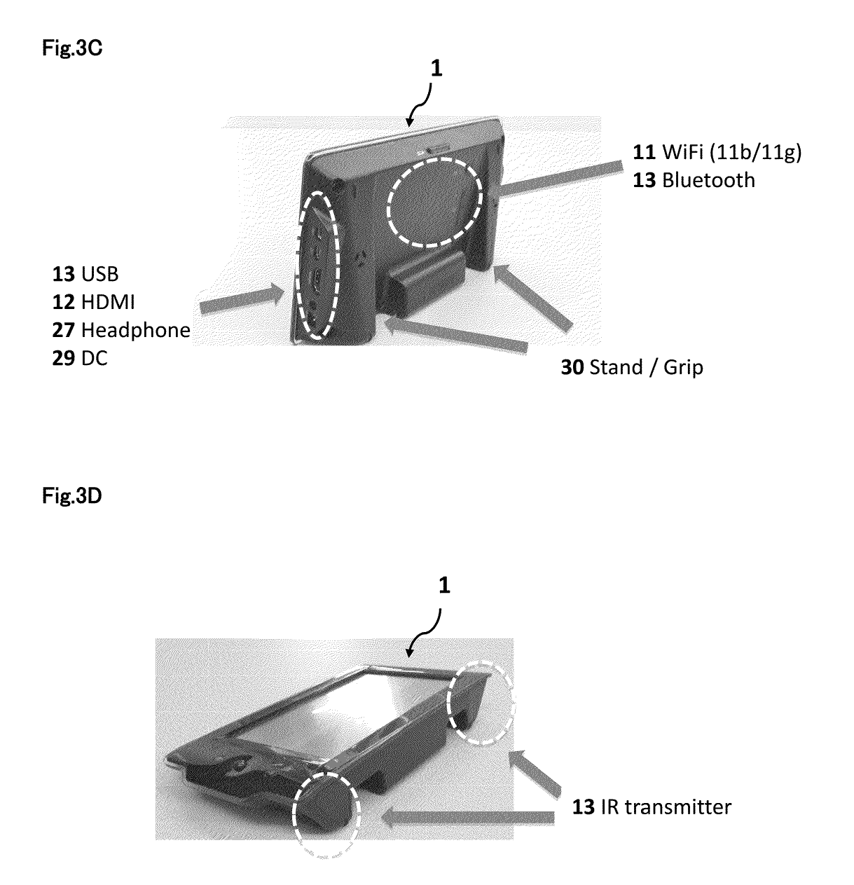

FIGS. 3A to 3D are examples of the appearance of a highly integrated handheld device. FIG. 3A shows the front appearance of the highly integrated handheld device, FIGS. 3B and 3C show the back appearance thereof, and FIG. 3D shows the bottom appearance thereof. As shown in FIG. 3A, the front of the highly integrated handheld device 1 has a 7-inch liquid crystal display screen (equipped with touch panel) 10, a camera 17, an operation button 23, a microphone 26, etc. placed. In addition, as shown in FIGS. 3B and 3C, the back of the highly integrated handheld device 1 has a Wi-Fi communication unit 11, a Bluetooth communication unit 13, a power button 23, a volume control button 23, speakers (R and L) 27, etc. placed. In addition, the top thereof has an SD card slot 15 placed. In addition, the side thereof has an HDMI cable connecting unit 12, a USB connecting unit 13, a headphone connecting unit 27, a direct-current power cable connecting unit 29, etc. placed. As shown in FIG. 3D, the bottom of the highly integrated handheld device 1 has an IR transmission unit 13 placed. In addition, the highly integrated handheld device 1 includes a stand/holding unit 30. The stand/holding unit 30 is provided at an inclination angle to the liquid crystal display screen 10. Therefore, the highly integrated handheld device 1 can stand as shown in FIGS. 3A, 3B, and 3C, and lie as shown in FIG. 3D. Furthermore, it is also possible to hold the highly integrated handheld device 1 with the user's hand.

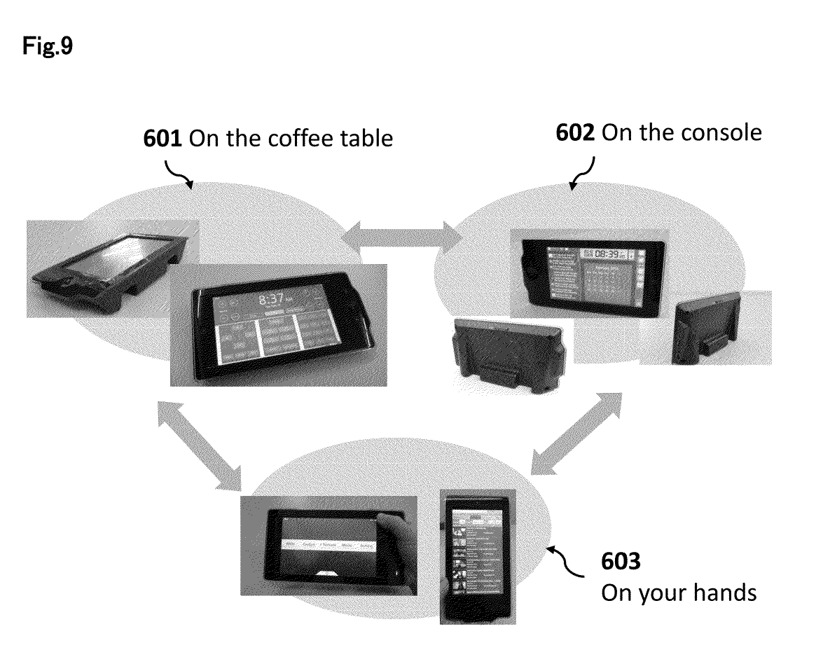

More specifically, the highly integrated handheld device 1 may be used while being placed on a table (601), or may be used while standing (602) from one situation to another, as shown in FIG. 9A. Alternatively, the highly integrated handheld device 1 may be used while being held by the user's hand (603). When the highly integrated handheld device 1 is used while being held by the user's hand, the liquid crystal display may be used in a horizontally long manner, or may be used in a vertically long manner. The highly integrated handheld device 1 can know its attitude through the acceleration sensing section 16, and thus display GUIs and the like in any orientation on the main body screen display unit 10. In an example of the highly integrated handheld device 1, the housing is made 233 mm×120 mm×39 mm in size and 485 g (1 lb) in weight in order to ensure the portability and visibility.

Specific operations for each function of the highly integrated handheld device 1 according to the present embodiment and GUIs will be described below with reference to FIGS. 1 to 8. First, when the user presses the power button 23 to activate the highly integrated handheld device 1, the control unit ensures a frame buffer in the main memory 22, if needed, and displays a Home Menu 100 on the main body display screen 10 as shown in FIG. 4. This Home Menu 100 has icons displayed for selecting “Multimedia Player Application”, “Universal remote controller Application”, “GADGET Application”, “Internet Movie Database”, “Setting”, etc. When the user selects any of the icons through the touch screen provided in the main body display screen 10, the control unit 20 switches the screen from the Home Menu 100 to the GUI (“Multimedia Player”, “Universal remote controller” “Gadget”, or “IMDb”) provided by the selected application.

### [Multimedia Player Application]

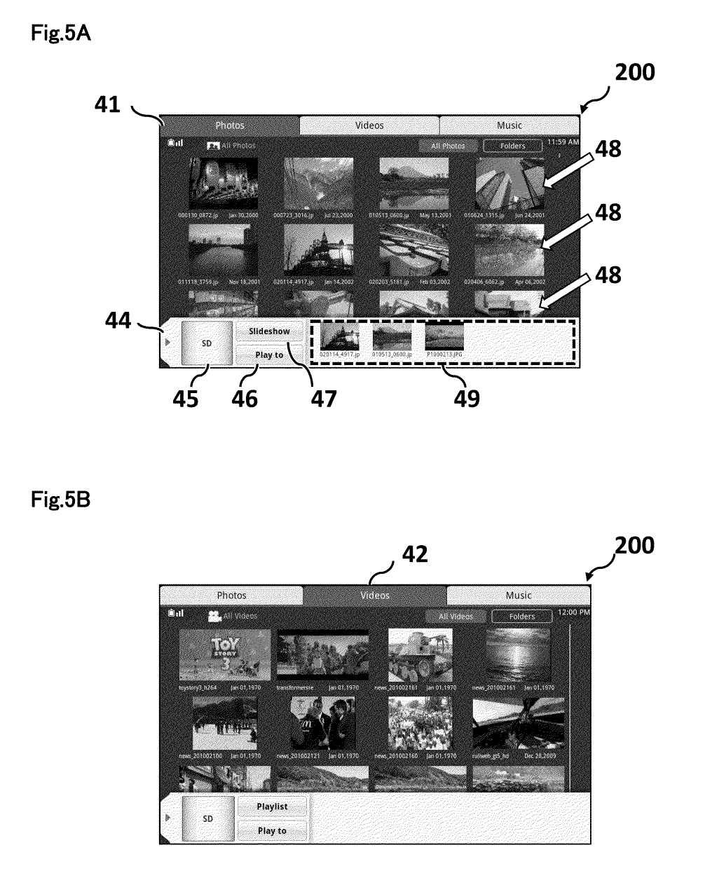

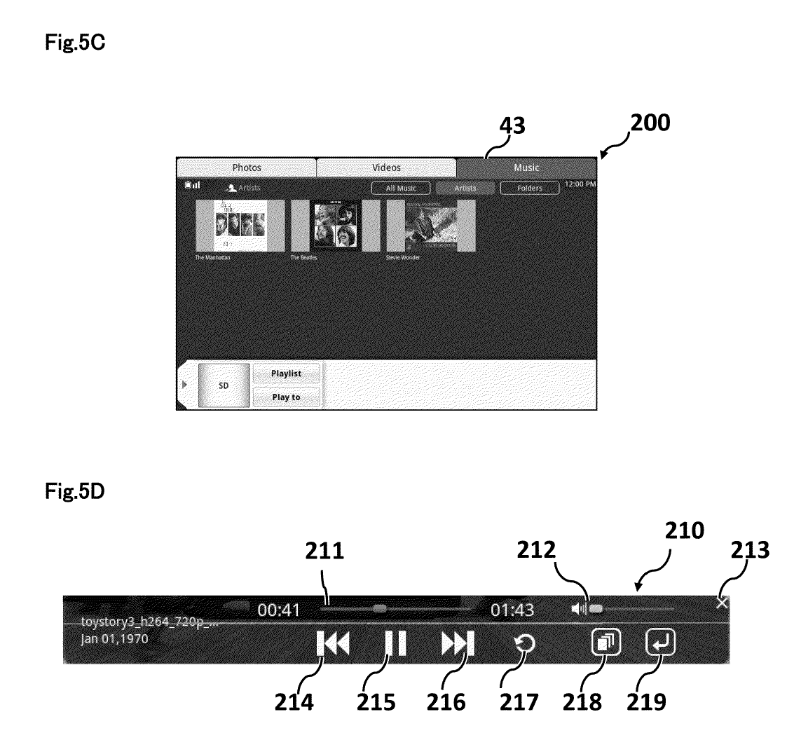

FIGS. 5A to 5D are examples of a first GUI 200 provided when the highly integrated handheld device 1 functions as Multimedia Player. In the first GUI 200, when switching tabs 41 to 43 are tapped by the user, the screens in respective modes (Photo, Video, and Music) will be active. FIGS. 5A to 5C are respectively examples of the screens in the Photo mode, Video mode, and Music mode.

For example, referring to FIG. 5A, thumbnails 48 for each content and a menu bar 44 are displayed on the screen in the switching tab 41.

The menu bar 44 includes a content supply source selection menu (Media Roller) 45, a content reproducing and displaying destination selection menu 46, and a playlist edit menu 47. The content supply source selection menu 45 has, for example, a content supply source (the content storage device (DMS) 3, the storage unit (Local Storage) 21, the server 8 on the Internet 90, etc.) displayed in response to a tap operation of the user. The sever 8 refers to a server for providing various types of services (for example, Image hosting web service), which specifically contains PICASA (Registered Trademark) web album, etc. The user can select a content supply source through the content supply source selection menu 45. The content reproducing and displaying destination selection menu 46 has, for example, a content reproducing and displaying destination (the main body display screen (LCD) 10, the first display device (DMR) 4, the second display device (External Display via HDMI) 6, etc.) displayed in response to a tap operation of the user. The user can select a content reproducing and displaying destination through the content reproducing and displaying destination selection menu 46.

When the user selects a content supply source, the control unit 20 acquires information on contents stored in the selected content supply source, and displays the thumbnails 48 for each content on the screen in each mode, for each type (for example, Photo, Video, Music) of the acquired contents.

Then, when the user selects some of the thumbnails 48 and manipulates the playlist edit menu 47, the contents to be reproduced and displayed are specified as a playlist, and the playlist is displayed in a region 49. In addition, the user may drag and drop some of the thumbnails 48 into the region 49.

When the user selects a reproducing and displaying destination, the control unit 20 reproduces and displays the specified contents in the reproducing and displaying destination in accordance with the playlist. For example, when the “main body display screen (LCD) 10” is selected as the content reproducing and displaying destination, the control unit 20 acquires the specified contents from the content supply source, and reproduces and displays the specified contents on the “main body display screen (LCD) 10”.

In the case of the contents of moving images, the control unit 20 may display a control bar 210 for controlling the reproduction and display of the moving image in the first GUI 200, as shown in FIG. 5D. The control bar 210 includes, for example, a Seek bar 211, a Volume Control 212, a Close button 213, a Previous (Tap)/Rewind (Long tap) button 214, a Pause/Play button 215, a Next (Tap)/Forward (Long tap) button 216, a Repeat button 217, an Add Playlist button 218, and an End button 219. When the “first display device 4” is selected as the content reproducing and displaying destination, the control unit 20 transfers the selected contents from the content supply source to the first display device 4 via the internal network 80, and reproduces and displays the contents in the first display device 4.

When the “second display device 6” is selected as the content reproducing and displaying destination, the control unit 20 acquires the selected contents from the content supply source, outputs the acquired contents to the “second display device 6”, and reproduces and displays the contents in the “second display device 6”. In this case, the control unit 20 may use a scaler to carry out scaling on the number of pixels for the contents appropriately. In addition, the control unit 20 may reproduce and display the acquired contents on the main body display screen 10 at the same time as in the “second display device 6”.

As described above, according to the present embodiment, the highly integrated handheld device 1 can, as a multimedia player, reproduce and display various types of contents on the internal network 80 in the first devices (including the main body display screen 10), and also reproduce and display the various types of contents in the second devices. In addition, the highly integrated handheld device 1 can reproduce and display, on the main body display screen 10, various types of contents on the external network 90, and also reproduce and display the various types of contents in the second devices. Therefore, the highly integrated handheld device 1 according to the present embodiment can achieve a seamless environment, even when there is a mix of the first devices (DLNA compliant devices) and the second devices (DLNA noncompliant devices) at home.

### [Universal Remote Controller Application]

FIGS. 6A to 6E are examples of a second GUI 300 provided when the highly integrated handheld device 1 functions as Universal remote controller. FIG. 6A is an overall view of the second GUI 300, whereas FIGS. 6B to 6E are detailed views of the second GUI 300. The second GUI 300 may be provided to the main body display screen 10, or provided to the distant information terminal 9 via a Web browser.

As shown in FIGS. 6A and 6B, the second GUI 300 includes two regions of Common Control Panel 310 and Unique Control Panel 330. The Common Control Panel 310 includes TV remote buttons 311 to 318 which are used daily and controlled device selection buttons 319 and 321. The Unique Control Panel 330 is a Control Panel unique to a controlled device selected by the user. The most commonly used controlled device may be assigned preferentially, or the controlled devices may be assigned in the order of the most recent user history to the controlled device selection buttons 319 and 321.

When the controlled device is selected by a user operation, the control section 20 displays the Control Panel 330 corresponding to the selected controlled device. The Control Panel 330 is displayed which includes volume control, channel switching, and number input panels. In addition, as shown in FIG. 6C, the Control Panel 330 may be configured to be scrollable.

In addition, as shown in FIG. 6D, for example, when the controlled device selection button (“Other Devices”) 321 is selected by the user, the control unit 20 may display a controlled device selection menu 340. The controlled device selection menu 340 contains devices (the first devices and the second devices) which is able to be controlled by the highly integrated handheld device 1. For example, when the “DVD” is selected by the user from the controlled device selection menu 340, the control unit 20 displays the Control Panel 330 corresponding to the “DVD”. Alternatively, for example, when the “Air Conditioner” is selected, the Control Panel 330 is displayed which contains temperature, humidity, timer, and air volume switching. Further, when it is not possible to display all of many controlled devices on the Unique Control Panel 330, the scrolling function may be used to scroll the screen from side to side or up and down.

When the control unit 20 receives a remote control operation input by the user, the control unit 20 transmits a control signal through any one of the first connection unit 11 to the third connection unit 13 to the target controlled device, depending on the connection mode of the controlled device. For example, when the controlled device is a “TV” as a DLNA compliant device, the control unit 20 transmits a control signal (IP remote control signal) from the first connection unit 11 to the “TV” via the network 80.

Alternatively, for example, when the controlled device is an “Air Conditioner” as a DLNA noncompliant device, the control unit 20 transmits a control signal (infrared remote control signal) from the third connection unit 13 to the “Air Conditioner”. When the “Air Conditioner” is installed in another room out of the range of access via infrared communication, the control unit 20 may transmit a control signal (IP remote control signal) from the first connection unit 11 to the other highly integrated handheld device 1 (or the remote control repeater) for relaying via the internal network 80. In this case, the other highly integrated handheld device 1 (or the remote control repeater) converts the received control signal (IP remote control signal) to a control signal (for example, an infrared remote control signal) corresponding to the target “Air Conditioner”, and transmits the converted control signal (infrared remote control signal) to the “Air Conditioner”.

As described above, according to the present embodiment, the highly integrated handheld device 1 can transmit, as a universal remote controller, various types of control signals directly or via the internal network 80 to not only DLNA compliant devices but also legacy home appliances 7 as DLNA noncompliant devices. Therefore, the user can operate not only DLNA compliant devices installed at home, but also most legacy home appliances 7 including an infrared communication light receiving unit with the use of the highly integrated handheld device 1.

In addition, the highly integrated handheld device 1 can also provide a GUI for remote control to the other information terminal 9 via the Internet 90 or the like. Therefore, the user can also operate home controlled devices (DLNA compliant devices and DLNA noncompliant devices) outside the home. It is to be noted that the user may go out while carrying the highly integrated handheld device 1 itself. In this case, the highly integrated handheld device 1 away from the DLNA network 80 can also connect to the DLNA network 80 via the Internet 90 or the like to operate the home controlled devices.

### [GADGET Application]

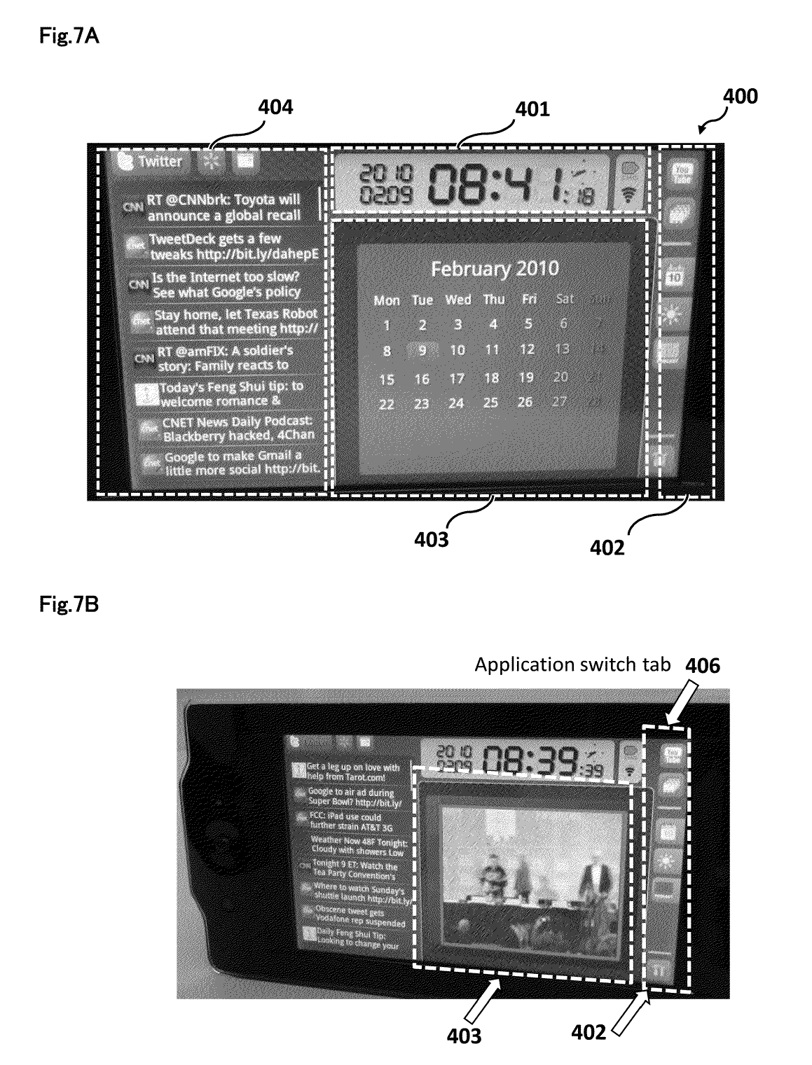

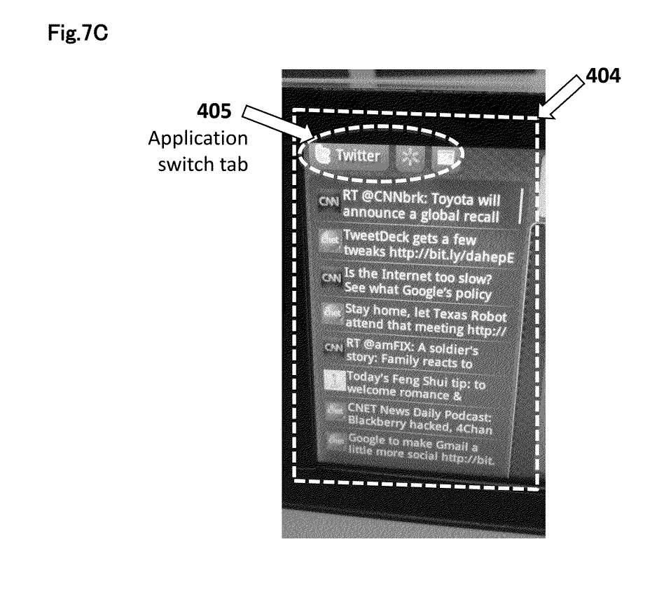

FIGS. 7A to 7C are examples of a third GUI 400 provided when the highly integrated handheld device 1 functions as GADGET (Registered Trademark). In this mode, with relatively frequently used applications and favorite applications registered in advance, the main body display screen is divided to display multiple applications at the same time. For example, as shown in FIG. 7A, the screen is divided into regions including a clock display section 401 for displaying a date and a time, etc., an application selection panel 402, a main panel 403, and a subpanel 404 in the third GUI 400. The application selection panel 402 contains icons for various types of applications.

As shown in FIG. 7B, the application selection panel 402 has multiple Application switch tabs 406 arranged. The Application switch tabs 406 specifically refer to applications such as a short message posting site (TWITTER (Registered Trademark)), online shopping information, schedule information, a calendar, a weather forecast, news, a moving image posting site (YouTube (Registered Trademark)), a camera, mails, chat, maps, telephones, and a search site (for example, Google (Registered Trademark)), which are registered by the user initially or if necessary. When the Application switch tab 406 is selected by a tap operation of the user, the control unit 20 provides the service provided by the selected application to the main panel 403 or the subpanel 404. The main panel 403 is a screen for mainly displaying text information and video, which provides, for example, a calendar, a weather forecast, news video, etc.

As shown in FIG. 7C, the subpanel 404 is a screen for mainly displaying services mainly based on text information, which may be configured such that multiple applications can be switched by an Application switch tab 405. Specifically, the subpanel 404 provides an incoming mail list, a short message posting side, a news site, shopping information, schedule information, etc. It is to be noted that the control unit 20 may, if necessary, switch the third interface 400 to a full-screen display to provide the service provided by the selected application to the full screen.

### [Specialized Browser for IMDb]

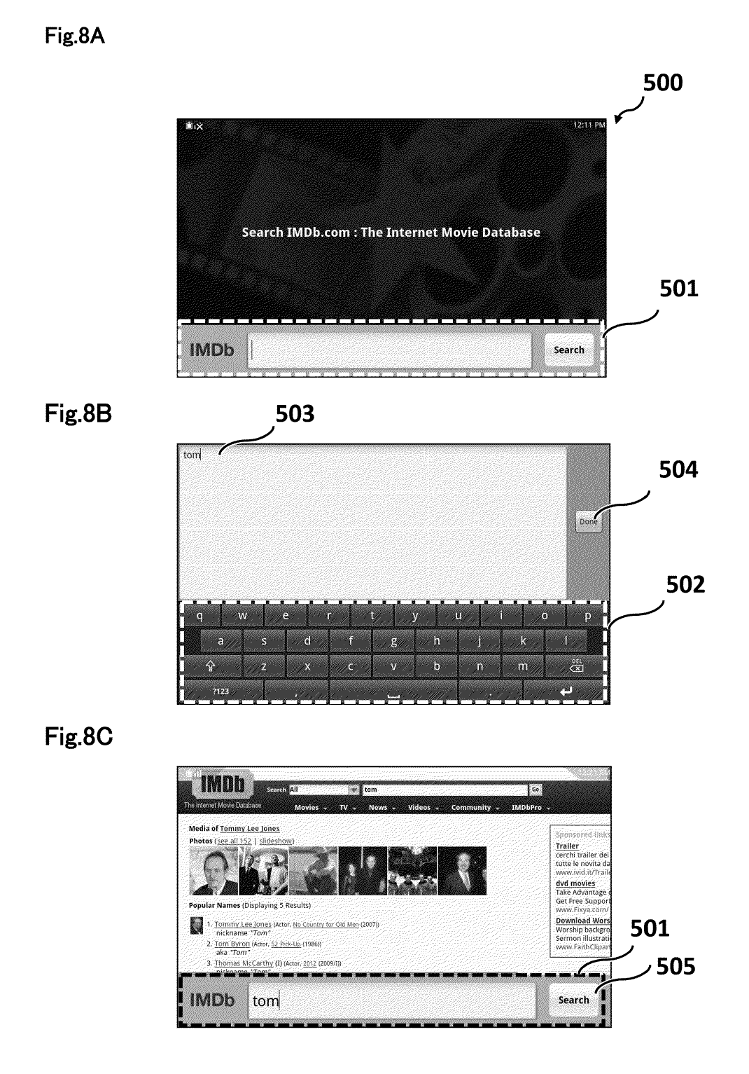

FIGS. 8A to 8C are examples of a GUI 500 in IMDb (Internet Movie Database) browser. As shown in FIG. 8A, a search window 501 to which search terms are to be input is displayed in the GUI 500. When a portion of the search window 501 is tapped by the user, the control unit 20 displays an enlarged search window 503, an input end button 504, a software keyboard 502, etc. in the GUI 500 as shown in FIG. 8B. When the user operates the software keyboard 502 to input at least a portion of a search term in the enlarged search window 503 and operate the input end button 504, the control unit 20 displays the search window 501 as shown in FIG. 8C. Then, when a search button 505 is tapped, the control unit 20 displays the search results in the GUI 500.

As described above, the highly integrated handheld device 1 is configured to achieve the reduction in size and weight for the purpose of easiness to carry around in the present embodiment, and provides GUIs intensively containing various types of frequently used Web services, etc. Thus, the user can readily use Web services in place of personal computers, etc. through the main component display screen including the touch screen.

As described above, the highly integrated handheld device 1 according to the present embodiment has all the function of “Multimedia Player Application”, the function of “Universal remote controller Application”, the function of “GADGET Application”, and the function of “Internet Movie Database” therein, which is an integrative device organically combining these functions, thereby allowing the control and management of contents, the control and management of various home appliances at home, and the retrieval of information (including contents) via the Internet. The highly integrated handheld device 1 is able to reproduce moving images and search the internet by itself, and further able to allow various home appliances to display the reproduced moving images and the Internet search, while the highly integrated handheld device 1 is regarded as a remote controller at home.

While the GUIs for the highly integrated handheld device 1 have been described, the GUIs shown in FIGS. 4 through 8C are just examples, and the present invention is not limited to the examples. In addition, various modifications, changes, and substitutions can be made. For example, the GUIs for the highly integrated handheld device 1 may further include a standard GUI provided by a common OS (for example, Android (Registered Trademark)) for highly integrated handheld devices.

In addition, in other embodiments, the highly integrated handheld device 1 can be configured to make Internet telephone, Internet television, Internet radio, e-mail, video chat, voice chat, etc. available through a connection to the Internet 90, as in the case of common personal computers. Furthermore, in other embodiments, the highly integrated handheld device 1 may be configured as a portable navigation device including the function of receiving GPS signals.

1. A highly integrated handheld device capable of connecting to an internal network built in conformity with a predetermined standard, the highly integrated handheld device comprising:
a control unit;
a storage unit;
a main body display unit;
a first connection unit capable of communicating directly or via the internal network with a first device compliant with the predetermined standard;
a second connection unit capable of connecting to a second device not compliant with the predetermined standard; and
a third connection unit capable of at least one of near field communication and infrared communication,
wherein the control unit can reproduce and display contents stored in the storage unit or the first device connected to the internal network, in the first device connected to the internal network, the second device connected through the second connection unit, and the main body display unit,
the control unit can transmit control signals for operating controlled devices including the first device and the second device, to the controlled devices through any of the first connection unit to the third connection unit, and
the control unit can divide the main body display unit into multiple screens to display multiple registered applications on the respective screens.

2. The highly integrated handheld device according to claim 1, wherein the first connection unit is capable of connecting to an external network.

3. The highly integrated handheld device according to claim 2, wherein the control unit acquires contents from a server connected to the external network, and
reproduces and displays the acquired contents in at least one of the main body display unit and the second device.

4. The highly integrated handheld device according to claim 2, wherein the control unit provides, to a screen of the main body display unit, a first graphical user interface for selecting a content supply source, a content reproducing and displaying destination, and contents to be reproduced and displayed.

5. The highly integrated handheld device according to claim 1, wherein the control unit provides, to a screen of the main body display unit, a second graphical user interface for operating the controlled devices, and
transmits control signals for controlling the controlled devices to the controlled devices, on the basis of an operation input through the provided second graphical user interface.

6. The highly integrated handheld device according to claim 5, wherein the control unit transmits the control signals to the controlled devices, and receives execution results for the control signals from the controlled devices, through any of the first connection unit to the third connection unit.

7. The highly integrated handheld device according to claim 6, wherein the third connection unit conforms with Bluetooth (Registered Trademark) as standards for near field communication.

8. The highly integrated handheld device according to claim 6, wherein the control unit transmits, through the first connection unit, the control signals to the first device connected to the internal network.

9. The highly integrated handheld device according to claim 6, wherein the first connection unit is capable of connecting to an external network, and
the control unit displays the second graphical user interface on an information terminal connected to the external network, and
transmits the control signals on the basis of a signal input from the information terminal.

10. The highly integrated handheld device according to claim 1, wherein the control unit provides, to a screen of the main body display unit, a third graphical user interface for using various types of services provided from the server.

11. The highly integrated handheld device according to claim 1, wherein the main body display unit comprises a touch screen capable of receiving operations from a user.

12. The highly integrated handheld device according to claim 1, wherein the control unit converts the number of pixels for contents stored in the first device or the storage unit to the number of pixels corresponding to the second display device, in accordance with processing for scaling, and
reproduces and displays the contents with the number of pixels converted in the second display device.

13. The highly integrated handheld device according to claim 1, wherein the internal network conforms with DLNA (Registered Trademark), and
the first connection unit conforms with at least one of Ethernet (Registered Trademark) and Wi-Fi (Registered Trademark).

14. The highly integrated handheld device according to claim 1, wherein the second connection unit conforms with HDMI (Registered Trademark).
